(19) United States
(12) Patent Application Publication
(10) Pub. No.: US 2026/0010387 A1
(43) Pub. Date: Jan. 8, 2026

(54) METHOD AND SYSTEM FOR DYNAMICALLY CREATING AN APPLICATION TO ASSIST USERS IN PERFORMING TASKS

(71) Applicant: LTI Mindtree Ltd, Mumbai (IN)

(72) Inventors: Ramesh Revuru, Mumbai (IN); Yusufzai Khan, Mumbai (IN)

(21) Appl. No.: 19/246,825

(22) Filed: Jun. 24, 2025

(30) Foreign Application Priority Data
Jul. 4, 2024 (IN) 202421051384

(51) Int. Cl. G06F 9/451; G06F 40/30

(52) U.S. Cl. CPC G06F 9/453; G06F 40/30

(57) ABSTRACT

The present disclosure discloses a task execution system and a method for dynamically creating an application for performing a task as per a user's request. The system includes a discovery module for discovering existing solutions that are capable of performing the task. Upon determining, by a determination module, that none of the discovered existing solutions performs the task, an integration module dynamically combines two or more existing solutions to create an application that can perform the task. Combining two more solutions involves defining an input, a process, an output, and an appropriate status for the application, and also involves creating a sequence for the two or more solutions within the application. An execution module then executes the application to perform the task. The task execution system continuously refines the application based on performance metrics, user feedback, and changing conditions to generate predictive analytics-driven suggestions.

### FIELD

Various embodiments of the present disclosure generally relate to task management and automation in enterprises. More specifically, the method and system relate to the discovery, integration, and execution of diverse tasks to optimize operational efficiency and enhance productivity within the enterprises.

### BACKGROUND

In today's corporate environments, large to medium enterprises are inundated with a multitude of standalone tasks scattered across various departments and systems. These tasks encompass a wide array of functions, including process flows, sub-process flows, automation bots, integration flows, and APIs. As organizations strive to streamline their operations and achieve their objectives, employees often find themselves searching for these tasks to fulfill specific objectives.

However, despite the vast array of tasks available within an enterprise, there are instances where existing solutions do not adequately meet the requirements of a particular task. This scenario poses a significant challenge, as it hampers productivity, disrupts workflow continuity, and impedes the organization's ability to respond swiftly to business demands.

The manual search for alternative solutions or the development of new ones to address these gaps is a time-consuming and resource-intensive process. Moreover, it often leads to suboptimal solutions that fail to fully leverage the existing resources and capabilities within the enterprise.

Furthermore, even when a diverse range of tasks exists within the organizational ecosystem, combining them to address specific needs can be a daunting task. Each task may come with its own unique workflow, data format, and protocols, making seamless integration and execution a complex endeavor. This heterogeneity introduces challenges in interoperability, data exchange, and workflow orchestration, exacerbating the difficulty of effectively leveraging the full spectrum of available resources.

Therefore, there is a need for a method and system that automates the discovery of existing solutions for performing a task and dynamically creating an application to assist a user in performing the task thereby streamlining and enhancing task management process for enterprises.

### SUMMARY

The present disclosure discloses a method and system for dynamically creating an application to assist a user in performing a task. The method and system upon receiving a user request via a user interface (UI), analyzes the request using natural language processing (NLP) to determine task requirements. Upon determining task requirements, a discovery module discovers one or more existing solutions capable of fulfilling the task requirements, wherein the existing solutions can be such as, process-flows, sub-process-flows, integration flows, APIs, automation bots, applications, and system components. Discovery of the one or more existing solutions comprises analyzing metadata associated with the process-flows, sub-process-flows, integration flows, APIs, automation bots, applications, and system components. Subsequently, a determination module determines if any of the discovered existing solutions can perform the task. Upon identifying that no suitable existing solutions performs the task, an integration module dynamically combines two or more existing solutions to create an application that is capable of performing the task, wherein combining the two or more existing solutions comprises identifying two or more existing solutions based on predefined rules and logic tailored to the task requirements.

Combining two or more solutions by the integration module to create an application involves defining an input, a process, an output, and an appropriate status for the application, and also involves creating a sequence for the two or more solutions within the application. While combining, the integration module employs a uniform protocol to ensure compatibility among the two or more existing solutions.

An execution module then executes the application to perform the task based on the user request, wherein the execution comprises interacting with the user to receive additional inputs as needed for performing the task. The execution module constantly monitors the execution of the application to detect and address any errors or discrepancies, and also receives feedback from the user based on execution of the application.

### BRIEF DESCRIPTION OF THE FIGURES

FIG. 1 is a diagram that illustrates an exemplary environment 100 within which the method and system for dynamically creating an application to perform a task may function, in accordance with various embodiments of the disclosure.

FIG. 2 is a diagram that illustrates a task execution system 106 for creating and executing an application, in accordance with an embodiment of the disclosure.

FIG. 3 is a diagram that illustrates a flow chart 300 for a method for dynamically creating and executing an application, in accordance with an embodiment of the disclosure.

FIG. 4 is a diagram that illustrates a flow chart 400 for mixing, matching, and executing the flow, in accordance with an embodiment of the disclosure.

### DETAILED DESCRIPTION

Various embodiments of the disclosure disclose a method and system for discovering existing solutions that are capable of fulfilling task requirements and combining two or more existing solutions to dynamically create an application, upon determining that none of the existing solutions that can perform the task. The created application is thus executed to perform the task as per the user's request.

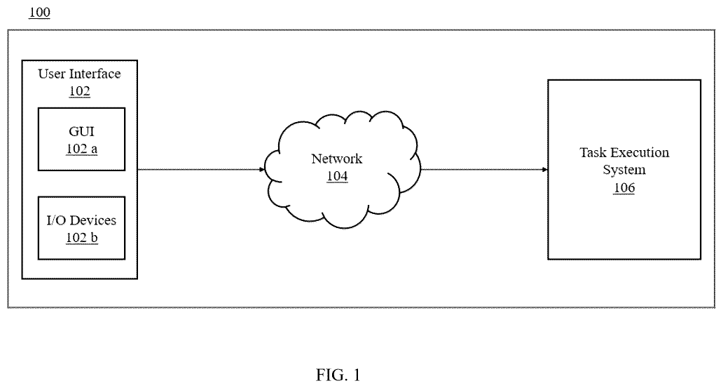

FIG. 1 illustrates an exemplary environment 100 within which the method and system for dynamically creating and executing an application may function, in accordance with various embodiments of the disclosure. Referring to FIG. 1, the environment 100 comprises a user interface (UI) 102, a graphical user interface (GUI) 102a, I/O devices 102b, a network 104, and a task execution system 106.

The UI 102 serves as a point of interaction between the task execution system 106 and a user. It facilitates user input, displays information, and enables users to navigate and interact with the task execution system 106. The UI 102 encompasses various elements, including graphical elements, input fields, and other interactive components that enhance user experience.

A user inputs a user request via the UI 102 to the task execution system 106. Upon receiving the user request, the task execution system 106 utilizes Natural Language Processing (NLP) techniques to analyze the underlying task requirements. Through dedicated algorithms and linguistic analysis, the user's input is parsed, dissected, and interpreted to extract essential insights regarding the desired workflow parameters, objectives, and constraints.

In some non-limiting embodiments, the NLP techniques enable the task execution system 106 to understand the user's intent, identify key action verbs, identify relevant nouns, and extract contextual hints embedded within the request. By leveraging semantic understanding and syntactic analysis, the task execution system 106 identifies specific activities, processes, or tasks implicated by the user's query or input.

The GUI 102a (e.g., a touchscreen, a display, etc.) represents a specific subset of the UI 102, focusing on visual elements and the interactive components designed to enhance user engagement. Through the GUI 102a the user can interact with the task execution system 106 using intuitive graphical controls, and gestures. By leveraging the GUI 102a, the user can easily navigate complex workflows, visualize relationships between activities, and make informed decisions in real-time.

The I/O devices 102b (e.g., a mouse, a keyboard, touchscreens, scanners, sensors, etc.) constitute hardware peripherals that facilitate the exchange of data between the UI 102 and external entities. I/O devices 102b enables the user to input commands, data, and instructions, allowing the user to interact with the task execution system 106.

The network 104 includes communication networks operable to facilitate communication, either wirelessly or wired. Any of the communications networks may include, but are not limited to, any one of a combination of different types of suitable communications networks such as, for example, broadcasting networks, cable networks, public networks (for example, the Internet), private networks, wireless networks, cellular networks, or any other suitable private and/or public networks. Further, any of the communication networks may have any suitable communication range associated therewith and may include, for example, global networks (for example, the Internet), metropolitan area networks (MANs), wide area networks (WANs), local area networks (LANs), or personal area networks (PANs). In addition, any of the communications networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Generally, the UI 102 is operable to communicate with the network 104 and may include logic encoded in software, hardware, or a combination of software and hardware. More specifically, the UI 102 may include software supporting one or more communication protocols associated with communication such that the network 104 is operable to communicate physical signals within and outside the task execution system 106.

The task execution system 106 combines two or more existing solutions to dynamically create an application to assist the user in performing one or more tasks in an enterprise. The task execution system 106 mainly operates in three steps: automated discovery, standardization by defining Input-Process-Output-Status (IPOS) for creating an application and executing the application.

Within large and medium enterprises, a plethora of tasks and processes exist, spanning across departments and systems. The task execution system 106 executes this process by leveraging one or more advanced algorithms and data analysis techniques.

Following the discovery process, the task execution system 106 performs standardization. Given the diverse nature of enterprise tasks, which often operate with different protocols, formats, and interfaces, achieving interoperability and consistency becomes predominant. To address these challenges, the task execution system 106 defines IPOS framework for each discovered task of the enterprise, which delineates the key components and attributes for each task, including input requirements, processing steps, output formats, and status indicators. By standardizing based on the IPOS framework, the task execution system 106 establishes common language and structure that facilitates seamless integration and orchestration.

Having standardized, the task execution system 106 performs mixing and matching for application execution, by employing one or more machine learning techniques to intelligently orchestrate workflows tailored to specific user objectives. By analyzing characteristics, dependencies, and constraints of each activity, the task execution system 106 identifies optimal combinations that align with user-defined requirements.

In an exemplary embodiment, the one or more machine learning techniques that are employed for performing mixing and matching can be such as, but not limited to, clustering techniques, collaborative filtering techniques, content-based filtering techniques, reinforcement techniques, deep learning techniques, and ensemble learning techniques.

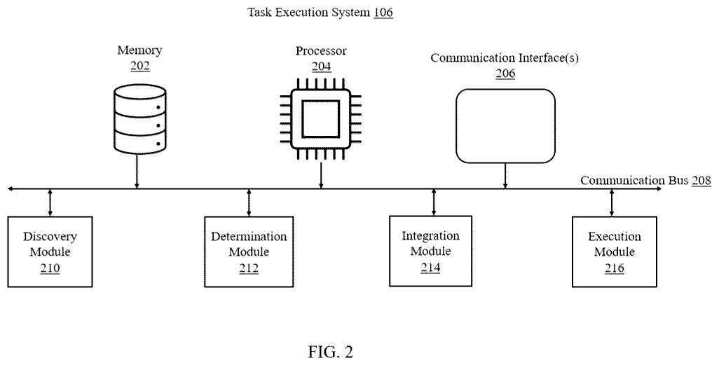

FIG. 2 is a diagram that illustrates the task execution system 106 for creating and executing an application, in accordance with an embodiment of the disclosure. Referring to FIG. 2, the task execution system 106 comprises a memory 202, a processor 204, one or more communication interface(s) 206, a communication bus 208, a discovery module 210, a determination module 212, an integration module 214, and an execution module 216.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the task execution system 106 in accordance with various aspects of the present disclosure. The processor 204 may be further configured to communicate with various modules of the task execution system 106 via the communication bus 208.

The communication interface(s) 206 may include one or more interfaces to enable the task execution system 106 to access a computer network such as a Location Area Network (LAN), a Wide Area Network (WAN), a Personal Area Network (PAN), or the internet through a variety of wired and/or wireless connections, including cellular connections.

The communication bus 208 is configured to serve the task execution system 106, facilitating seamless communication, integration, and coordination among its constituent components. Through its role as a centralized message broker, the communication bus 208 enables efficient data exchange, event-driven processing, and reliable communication, empowering the system to orchestrate complex workflows and achieve outputs.

The discovery module 210 may comprise suitable logic, interfaces, and/or code that may be configured to discover a plurality of existing solutions that has the capability to perform task requirements requested by the user. The discovery module 210 discovers the plurality of existing solutions by employing a combination of advanced machine learning algorithms, data mining techniques, knowledge graphs, and integration capabilities.

In an embodiment, the discovery module 210 employs NLP techniques to analyze a user's input to understand the underlying task requirements. Through dedicated algorithms and linguistic analysis, the user's input is parsed, dissected, and interpreted to extract essential insights regarding the desired application parameters, objectives, and constraints.

In some non-limiting embodiments, the NLP techniques enable the discovery module 210 to understand the user's intent, identify key action verbs, identify relevant nouns, and extract contextual hints embedded within the request. By leveraging semantic understanding and syntactic analysis, the discovery module 210 identifies specific activities, processes, or tasks implicated by the user's query or input.

In an embodiment, the discovery of existing solutions includes analyzing metadata associated with the process-flows, sub-process-flows, integration flows, APIs, automation bots, applications, and system components to assess their suitability for fulfilling the task requirements. The discovery module 210 is also configured to explore existing solutions distributed across various systems, platforms, and repositories within the enterprise.

In an embodiment, the advanced machine learning algorithms employed by the discovery module 210 can be such as, but not limited to, clustering algorithms, classification algorithms, collaborative filtering, anomaly detection, and sequential pattern mining. Similarly, the data mining techniques employed by the discovery module 210 can be such as, but not limited to, association rule mining, sequential pattern mining, clustering, classification, anomaly detection, and text mining.

### Exemplary Embodiment

Consider an exemplary embodiment, where an employee provides an input query via the UI 102, ‘I want to apply for a credit card as per company policy’.

The task execution system 106 extracts keywords and analyzes the input query using Natural Language Processing (NLP).

The discovery module 210 of the task execution system 106 performs a repository search and determines an application that is a perfect match for assisting the user with the user's requirement. Accordingly, the application seeks inputs as needed and executes the flow to perform the task for the user. In an instance, the input may be used to determine the eligibility criteria to execute the flow as per policy. However, on other hand, when the discovery module 210 doesn't find a single application that can perform the tasks on its own, the discovery module 210 may look for one or more applications which may perform sub-tasks of the task. For instance, the discovery module 210 may identify an application that may assess eligibility criteria for the user and another application that can raise a Service Request for applying for the card. Based on the repository search and the info received, a sequence is created defining IPOS.

In accordance with the exemplary embodiment, the sequence first checks eligibility of the employee as per policy document, and if the eligibility is determined, a service request created in another system. These activities are sequenced, and inputs are sought i.e., Grade of employee >Level-8. Additionally, the newly created sequence will be stored in the repository so that a similar query can get processed through perfect match in the future.

In some non-limiting embodiments, in addition to the metadata, the discovery module 210 may also leverages predefined search criteria, contextual relevance, enterprise data, documentation, and configuration files to extract information and insights to perform its discovery process. In an embodiment, the discovery module 210 incorporates adaptive learning mechanisms, continuously refining its search strategies and discovery algorithms based on feedback, usage patterns and evolving user requirements.

The determination module 212 may comprise suitable logic, interfaces, and/or code that may be configured to evaluate capabilities of the discovered existing solutions to ascertain whether they are suitable candidates for the defined task requirements. The determination module 212 serves as the decision-making engine, employing wide criteria and metrics to assess the suitability of each solution for performing the specified task.

Upon determination from the determination module 212 that there are no existing solutions that can perform the task, the determination module 212, with suitable logics, interfaces, and/or code is configured to analyzes the task to identify two or more sub-tasks within the task. Thereafter, the determination module 212 identifies two or more existing solutions that can execute the two or more sub-tasks of the task. By adeptly combining these the two or more existing solutions for executing two or more sub-tasks, the task execution system 106 enables the execution of the tasks even in the absence of any existing solutions that can execute the task individually.

The integration module 214 combines the two or more existing solutions by defining an input, a process, an output and an appropriate status for the application as per the user request. The integration module 214 creates a sequence for the two or more existing solutions within the application. This sequence is determined based on the dependencies and interdependencies among the selected existing solutions, ensuring optimal performance and seamless execution of the task at hand.

Defining an input by the integration module 214 includes data, commands, or requests coming from one or more sources, which is processed using predefined rules, logics, and algorithms. It then generates an output based on the processed input, which is passed on to the user. Dependencies and interdependencies among the two or more existing solutions can be data dependencies, functional dependencies, timing dependencies, resource dependencies, process dependencies, and regulatory dependencies.

Within the task execution system 106, the process of combining existing solutions is governed by a set of predefined rules and logics that are aligned with the requirements of each task. These rules and logic encompass a range of considerations, including functional compatibility, technical constraints, resource availability, and business objectives. By codifying these rules and logic, the task execution system 106 ensures consistency, repeatability, and reliability in the process of combining components into an application.

Creating sequence for the two or more solutions by the integration module 214 comprises configuring integration points and data flow paths between process-flows, sub-process-flows, integration flows, APIs, automation bots, applications, and system components for facilitating smooth collaboration and interaction.

Configuring integration points serve as interfaces or endpoints through which data and control signals are exchanged between the two or more existing solutions. The integration module 214 identifies and configures integration points based on specific requirements of each task, ensuring that data can flow freely and securely between interconnected tasks.

Combining the two or more existing solutions also involves prioritizing certain tasks based on their importance in achieving the task objectives. This prioritization ensures that resources are allocated effectively and that essential components receive necessary resources. In an instance, prioritization criteria may include factors such as business impact, strategic alignment, regulatory compliance, performance requirements, and stakeholder preferences.

To ensure seamless compatibility and interoperability among the combined two or more existing solutions, a uniform protocol is employed by the task execution system 106. The uniform protocol serves as a standardized set of rules, conventions, and communication protocols that govern the interactions and data exchange between the two or more existing solutions. By employing the uniform protocol, a common language and framework is established that enables entities to communicate, collaborate, and coordinate their actions effectively.

The uniform protocol facilitates seamless integration by defining consistent data formats, message structures, and communication mechanisms that all existing solutions to. This ensures that data exchanged between existing solutions is uniform in structure, enabling smooth interoperability and data interchange.

Additionally, the uniform protocol extends itself by accommodating various requirements and raising needs within the task execution system 106. It allows incorporation of new components, mechanisms, functionalities while maintaining compatibility with existing entities. Furthermore, the uniform protocol supports customization and configuration options, enabling the user to tailor communication protocols and data exchange mechanisms.

Defining the input and output by the integration module 214 as a part of combining the two or more existing solutions comprises implementing a common data model that facilitates collaboration and data exchange among the two or more existing solutions. The common data model establishes a standardized representation of data structures, entities, and attributes ensuring consistency and interoperability across the integrated system.

By implementing the common data model, the task execution system 106 establishes a distributed understanding of data semantics, enabling entities to exchange information in a unified manner. The common data model also defines standardized data formats, schemas, and ontologies that serves data exchange, regardless of varied technologies and systems that are involved.

By aligning data representations and semantics, the common data model enables integrated components to access, manipulate, and interpret data with ease, facilitating interoperability and information sharing.

In some non-limiting embodiment, the common data model supports extensibility, allowing incorporation of new data elements, attributes, or entities as the task execution system 106 evolves, in order to ensure that the common data model remains relevant and responsive to changing requirements, and emerging use cases within the enterprise ecosystem.

In an embodiment, the common data model may trigger a variety of events based on input specification. The events may encompass actions such as, but not limited to, data validation, transformation, enrichment, routing, aggregation, or notification. For instance, the common data model initiates a validation process to ensure that incoming data conforms to predefined standards and criteria. If validation fails, an error event may be triggered to alert the user to take corrective actions.

In accordance with the embodiment, the common data model can be programmed to respond to specific conditions or thresholds within the data. For instance, if certain data metrics exceed predefined thresholds, the common data model may trigger an alert event to notify the user or trigger an alert automated response.

The execution module 216 may comprise suitable logic, interfaces, and/or code that may be configured to implement and execute the created application to fulfill the user's request. Operating as an operational engine, the execution module 216 orchestrates execution of a single task or sequence of tasks, actions, and processes defined within the application to achieve the specified objectives. By leveraging predefined instructions, the execution module 216 ensures smooth progression of tasks, data flows, and interactions between integrated components, guiding the application from initiation to completion.

In an embodiment, the execution module 216 constantly communicates and interacts with the user to receive additional inputs as needed for performing the task. This functionality enables the task execution system 106 to adapt dynamically to the user needs, enhancing effectiveness and user experience. For instance, additional inputs needed from the user can be such as, specific parameters, preferences, or clarifications from the user to tailor the execution process accordingly.

In an exemplary embodiment, in a task involving data analysis, additional inputs could include criteria for filtering or sorting data. In a task related to scheduling, additional inputs might involve time constraints or preferences for particular dates or times. These inputs serve to customize the execution of tasks to better align with the user's objectives and preferences.

The execution module 216 executes the application in one or more sequences based on the input specification received from the common data model. Upon receiving the input specification, the execution module 216 analyzes the instructions and determines appropriate sequence to execute the application. These sequences may vary depending on factors such as user-defined preferences, conditional logic, event triggers, or dynamic data inputs.

In an exemplary embodiment, if the input specification instructs a series of sequential steps to be followed, the execution module 216 orchestrates the application's execution in a linear manner. Alternatively, if the input specification instructs parallel execution or conditional branching, the execution module 216 dynamically adjusts its execution strategy to accommodate the requirements. In such cases, the execution module 216, may concurrently execute multiple branches of the workflow in parallel, synchronize execution based on predefined conditions or dependencies, or dynamically adjust the application based on real-time data inputs or events triggered by the common data model.

Accordingly, throughout the execution process, the execution module 216 remains synchronized with the common data model, exchanging information, receiving updates, and responding to events triggered by the common data model, enabling coordination between the execution module 216 and the common data model.

In an embodiment, the execution module 216 is also configured to monitor execution of the created application to detect and address any discrepancies. The execution module 216 continuously monitors, scans for any sings of errors, discrepancies, and irregularities that may occur during the execution process. In instances where an error or a discrepancy is detected, the execution module 216 take actions to address the issue, wherein the actions can be such as, but not limited to, automated error recovery, automated notification/alerts, rerouting workflow paths, retrying failed tasks, triggering alternative execution paths.

The execution module 216 by employing real-time optimization algorithms, continuously refines the application based on performance metrics, user feedback, and changing environmental conditions. Through this iterative process, the execution module 216 dynamically adjusts its operation to enhance efficiency, adaptability, and accuracy. By analyzing performance metrics, the execution module 216 identifies areas for improvements and implements optimizations in real-time. Additionally, the user feedback serves as valuable input for refining the application's functionality and user experience. By proactively responding to changing environmental conditions, such as fluctuations in workload or resource availability, the execution module 216 maintains peak performance and adaptability, delivering a robust and responsive system.

The execution module 216 may employ a suite of monitoring mechanisms and error detection protocols to continuously monitor the execution. This mechanism systematically scrutinizes various aspects of application execution, including task completion, data flow, system interactions, and resource utilization. By constant monitoring, the execution module 216 tracks any deviations from expected behavior that could potentially comprise the application's integrity and disrupt its progress.

In accordance with the embodiment, the execution module 216 may be equipped with diagnostic capabilities that enables it to diagnose root cause or errors or discrepancies with precision and accuracy. By analyzing relevant data logs, system events, and execution traces, the execution module 216 can track the source of the problem and provide actionable insights for resolution.

Upon completion of application execution, the execution module 216 retrieves the output response, which may comprise diverse data types, formats, or structures. The execution module 216 then applies a transformation process that involves mapping the output data elements, attributes, and values to the standardized schema defined within the common data model.

This makes the output into a consistent format and can be seamlessly integrated with other system components, such as, for example, downstream processes, analytics engines, or reporting tools.

Further, the translation of the output response into the common data model structure facilitates interoperability and data exchange within the task execution system 106. By providing a standardized mechanism for data interpretation and processing, the common data model enables components to access, manipulate, and analyze output data with ease.

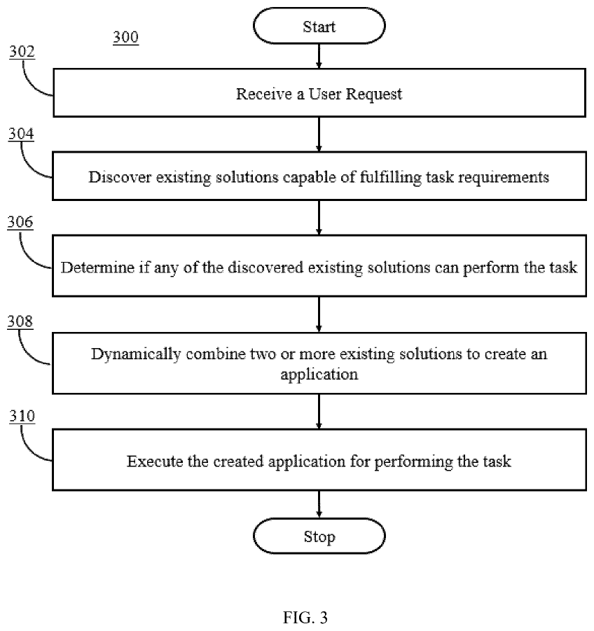

FIG. 3 is a diagram that illustrates a flow chart 300 for a method for dynamically creating and execute an application, in accordance with an embodiment of the disclosure.

At 302, a user inputs a user request via the UI 102 to the task execution system 106. Upon receiving the user request, the task execution system 106 utilizes NLP techniques to analyze the underlying activity requirements. Through dedicated algorithms and linguistic analysis, the user's input is parsed, dissected, and interpreted to extract essential insights regarding the desired workflow parameters, objectives, and constraints.

In some non-limiting embodiments, the NLP techniques enable the task execution system 106 to understand the user's intent, identify key action verbs, identify relevant nouns, and extract contextual hints embedded within the request. By leveraging semantic understanding and syntactic analysis, the task execution system 106 identifies specific activities, processes, or tasks implicated by the user's query or input.

At 304, the discovery module 210 discovers a plurality of existing solutions that has the capability to perform activity requirements articulated by the user.

The discovery module 210 discovers the plurality of existing solutions by employing a combination of advanced machine learning algorithms, data mining techniques, knowledge graphs, and integration capabilities.

In an embodiment, the discovery module 210 employs NLP techniques to analyze a user's input to understand the underlying task requirements. Through dedicated algorithms and linguistic analysis, the user's input is parsed, dissected, and interpreted to extract essential insights regarding the desired application parameters, objectives, and constraints.

In some non-limiting embodiments, the NLP techniques enable the discovery module 210 to understand the user's intent, identify key action verbs, identify relevant nouns, and extract contextual hints embedded within the request. By leveraging semantic understanding and syntactic analysis, the discovery module 210 identifies specific activities, processes, or tasks implicated by the user's query or input.

In an embodiment, the discovery of existing solutions includes analyzing metadata associated with the process-flows, sub-process-flows, integration flows, APIs, automation bots, applications, and system components to assess their suitability for fulfilling the task requirements. The discovery module 210 is also configured to explore existing solutions distributed across various systems, platforms, and repositories within the enterprise.

At 306, the determination module 212 evaluates capabilities of the discovered existing solutions to ascertain whether they are suitable candidates to perform the defined activity requirements. The determination module 212 serves as the decision-making engine, employing wide criteria and metrics to assess the suitability of each solution for performing the specified activity.

Upon determination from the determination module 212 that there are no existing solutions that can perform the task, the integration module 214, with suitable logics, interfaces, and/or code is configured to analyzes the task to identify two or more sub-tasks within the task. Thereafter, the determination module 212 identifies two or more existing solutions that can execute the two or more sub-tasks of the task. By adeptly combining these the two or more existing solutions for executing two or more sub-tasks, the task execution system 106 enables the execution of the tasks even in the absence of any existing solutions that can execute the task individually.

At 308, upon receiving a response from the determination module 212 that there are no existing solutions that can perform the activity, the integration module 214 dynamically combines to or more existing solutions to create an application to perform the task.

The integration module 214 combines the two or more existing solutions by defining an input, a process, an output and an appropriate status for the application as per the user request, and by creating a sequence for the two or more existing solutions within the application, wherein the sequence is determined based on dependencies and interdependencies among the two or more existing solutions.

Defining an input by the integration module 214 includes data, commands, or requests coming from one or more sources, which is processed using predefined rules, logics, and algorithms. It then generates an output based on the processed input, which is passed on to the user. Dependencies and interdependencies among the two or more existing solutions can be data dependencies, functional dependencies, timing dependencies, resource dependencies, process dependencies, and regulatory dependencies.

Within the task execution system 106, the process of combining existing solutions is governed by a set of predefined rules and logics that are aligned with the requirements of each task. These rules and logic encompass a range of considerations, including functional compatibility, technical constraints, resource availability, and business objectives. By codifying these rules and logic, the task execution system 106 ensures consistency, repeatability, and reliability in the process of combining components into an application.

Creating sequence for the two or more solutions by the integration module 214 comprises configuring integration points and data flow paths between process-flows, sub-process-flows, integration flows, APIs, automation bots, applications, and system components for facilitating smooth collaboration and interaction.

Configuring integration points serve as interfaces or endpoints through which data and control signals are exchanged between the two or more existing solutions. The integration module 214 identifies and configures integration points based on specific requirements of each task, ensuring that data can flow freely and securely between interconnected tasks.

Combining the two or more existing solutions also involves prioritizing certain tasks based on their importance in achieving the task objectives. This prioritization ensures that resources are allocated effectively and that essential components receive necessary resources. In an instance, prioritization criteria may include factors such as business impact, strategic alignment, regulatory compliance, performance requirements, and stakeholder preferences.

To ensure seamless compatibility and interoperability among the combined two or more existing solutions, a uniform protocol is employed by the task execution system 106. The uniform protocol serves as a standardized set of rules, conventions, and communication protocols that govern the interactions and data exchange between the two or more existing solutions. By employing the uniform protocol, a common language and framework is established that enables entities to communicate, collaborate, and coordinate their actions effectively.

Finally, at 310, the execution module 216 executes the created application to fulfill the user's request. Operating as an operational engine, the execution module 216 orchestrates execution of a single task or sequence of tasks, actions, and processes defined within the application to achieve the specified objectives. By leveraging predefined instructions, the execution module 216 ensures smooth progression of tasks, data flows, and interactions between integrated components, guiding the application from initiation to completion.

In an embodiment, the execution module 216 constantly communicates and interacts with the user to receive additional inputs as needed for performing the task. This functionality enables the task execution system 106 to adapt dynamically to the user needs, enhancing effectiveness and user experience. For instance, additional inputs needed from the user can be such as, specific parameters, preferences, or clarifications from the user to tailor the execution process accordingly.

The execution module 216 executes the application in one or more sequences based on the input specification received from the common data model. Upon receiving the input specification, the execution module 216 analyzes the instructions and determines appropriate sequence to execute the application. These sequences may vary depending on factors such as user-defined preferences, conditional logic, event triggers, or dynamic data inputs.

In an embodiment, the execution module 216 is also configured to monitor execution of the created application to detect and address any discrepancies. The execution module 216 continuously monitors, scans for any sings of errors, discrepancies, and irregularities that may occur during the execution process. In instances where an error or a discrepancy is detected, the execution module 216 take actions to address the issue, wherein the actions can be such as, but not limited to, automated error recovery, automated notification/alerts, rerouting workflow paths, retrying failed tasks, triggering alternative execution paths.

The execution module 216 by employing real-time optimization algorithms, continuously refines the application based on performance metrics, user feedback, and changing environmental conditions. Through this iterative process, the execution module 216 dynamically adjusts its operation to enhance efficiency, adaptability, and accuracy. By analyzing performance metrics, the execution module 216 identifies areas for improvements and implements optimizations in real-time. Additionally, the user feedback serves as valuable input for refining the application's functionality and user experience. By proactively responding to changing environmental conditions, such as fluctuations in workload or resource availability, the execution module 216 maintains peak performance and adaptability, delivering a robust and responsive system.

The execution module 216 may employ a suite of monitoring mechanisms and error detection protocols to continuously monitor the execution. This mechanism systematically scrutinizes various aspects of application execution, including task completion, data flow, system interactions, and resource utilization. By constant monitoring, the execution module 216 tracks any deviations from expected behavior that could potentially comprise the application's integrity and disrupt its progress.

In accordance with the embodiment, the execution module 216 may be equipped with diagnostic capabilities that enables it to diagnose root cause or errors or discrepancies with precision and accuracy. By analyzing relevant data logs, system events, and execution traces, the execution module 216 can track the source of the problem and provide actionable insights for resolution.

### Exemplary Embodiment

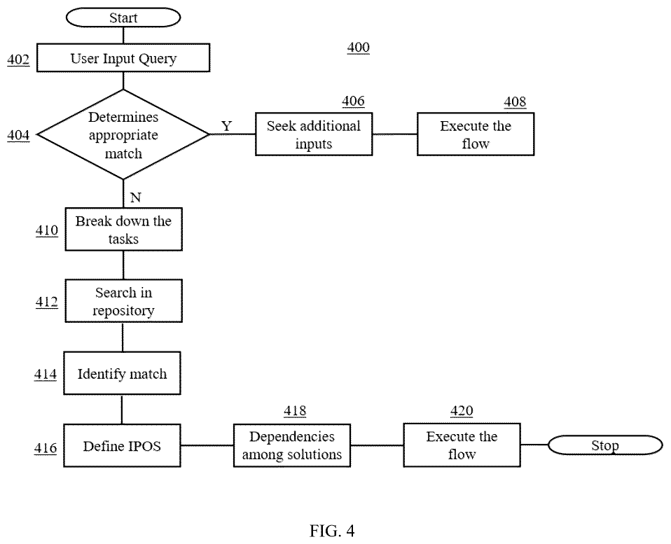

Consider an exemplary embodiment, as illustrated in FIG. 4, where a user provides an input query at 402, via the UI 102, ‘I want to apply for a credit card as per company policy’.

At 402, the task execution system 106 starts analyzing the input query by utilizing NLP techniques to understand underlying task requirements. By leveraging semantic understanding and syntactic analysis, the task execution system 106 identifies specific activities, processes, or tasks implicated by the user's query.

The discovery module 210 of the task execution system 106, based on the identified task requirement, initiates discovering a plurality of existing solutions that can perform the task. The discovery module 210 leverages keywords from the identified task requirement and initiates a search in the enterprise repository to discover the plurality of existing solutions. For instance, the existing solutions for the task requirement can be process-flows, sub-process-flows, integration flows, APIs, automation bots, applications, and system components.

At 404, if the determination module 212, based on the discovered plurality of existing solutions, determines an appropriate solution (match) for the user query, it directly initiates the execution module 216 to execute the flow by deploying the appropriate solution.

At 406, while executing the flow, the execution module 216 constantly interacts with the user to seek additional inputs as needed for performing the task at 408.

In a scenario, at 410, where the determination module 212, based on the identified task requirement, determines that there are no existing solutions capable of performing the task as requested by the user, it initiates the integration module 214 to break down the task into sub-tasks. Let's name the sub-tasks: “Eligibility Check,” “Document Submission,” and “Credit History Verification.”

At 412, the determination module 212 leverages keywords from the identified task requirement and initiates a search in the enterprise repository to discover the plurality of existing solutions for each sub-task. The discovery module 210 then identifies existing solutions for each of these sub-tasks.

Once the sub-tasks are identified, at 414, the determination module 212 proceeds to identify multiple existing solutions capable of addressing each sub-task. For example, for the “Eligibility Check” sub-task, existing solutions may include the “HR Policy Link” for employee eligibility verification. Similarly, for “Document Submission,” existing solutions may include the “Document Upload Service,” and for “Credit History Verification,” existing solutions may include the “Credit Bureau Integration.”

After identifying multiple existing solutions for each sub-task, the integration module 214, at 414 combines these solutions to create an application that can collectively perform the task corresponding to the user query. For example, the integration module 214 may integrate the “HR Policy Link,” “Document Upload Service,” and “Credit Bureau Integration” to create a seamless application for processing the corporate Amex card application.

The integration module 214, at 416, performs the step of combining the existing solutions by defining an input, a process, an output and an appropriate status for the application as per the user request, and by creating a sequence for the two or more existing solutions within the application, wherein the sequence is determined based on dependencies and interdependencies among the two or more existing solutions.

Defining an input by the integration module 214 includes data, commands, or requests coming from one or more sources, which is processed using predefined rules, logics, and algorithms.

At 418, the integration module 214 generates an output based on the processed input, which is passed on to the user. Dependencies and interdependencies among the two or more existing solutions can be data dependencies, functional dependencies, timing dependencies, resource dependencies, process dependencies, and regulatory dependencies.

At 420, the execution module 216 executes the created application to fulfil the user's request. The execution module 216 orchestrates execution of a single task or sequence of tasks, actions, and processes defined within the application to achieve the specified objectives. Additionally, while executing the flow, the execution module 216 constantly interacts with the user to seek additional inputs as needed for performing the task.

The method and system is advantageous over existing solutions in a way that it consolidates multiple functions into a single tool, thereby streamlining and enhancing workflow management process for medium and large enterprises. This includes comprehensive workflow lifecycle management, providing a unified solution that spans the entire workflow lifecycle from discovery to execution. Additionally, it facilitates efficient discovery and execution, empowering enterprises to identify, evaluate, and integrate a diverse range of existing workflows, APIs, bots, applications, and system components with ease. Furthermore, the disclosure enables optimized execution and resource utilization, allowing enterprises to streamline processes, enhance resource allocation, and ultimately improve operational efficiency.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A method for dynamically creating an application to assist a user in performing a task, comprising:
receiving a user request via a user interface, wherein the user request corresponds to the user;
discovering one or more existing solutions based on the user request, wherein the one or more existing solutions comprises process-flows, sub-process-flows, integration flows, APIs, automation bots, applications, and system components;
determining an existing solution of the one or more existing solutions that is capable of performing the task;
in response to determining that none of the one or more existing solutions are capable of performing the task, dynamically combining two or more existing solutions to create the application that is capable of performing the task; and
executing the application to perform the task based on the user request.

2. The method as claimed in claim 1, wherein the user request is analyzed using natural language processing (NLP) to determine application requirements.

3. The method as claimed in claim 1, wherein the discovery of one or more existing solutions comprises analyzing metadata associated with the process-flows, the sub-process-flows, the integration flows, the APIs, the automation bots, the applications, and the system components based on query parameters associated with the user request.

4. The method as claimed in claim 1, wherein the combining of the two or more existing solutions for creating the application comprises:
defining an input, a process, an output, and an appropriate status for the application as per the user request; and
create a sequence for the two or more existing solutions within the application, wherein the sequence is created based on dependencies and interdependencies among the two or more existing solutions.

5. The method as claimed in claim 4, wherein the combining of the two or more existing solutions comprises identifying the two or more existing solutions based on predefined rules and logic tailored to requirements of the task.

6. The method as claimed in claim 4, wherein the creating of the sequence for the two or more existing solutions comprises configuring integration points and data flow paths between the process-flows, the sub-process-flows, the integration flows, the APIs, the automation bots, the applications, and the system components for facilitating smooth collaboration and interaction.

7. The method as claimed in claim 4, wherein a uniform protocol is employed for ensuring compatibility among the two or more existing solutions.

8. The method as claimed in claim 4, wherein the defining of the input and the output comprises implementing a common data model for facilitating collaboration and data exchange among the two or existing solutions.

9. The method as claimed in claim 1, wherein the executing comprises interacting with the user to receive additional inputs for performing the task.

10. The method as claimed in claim 1, further comprising monitoring the execution of the application to detect and address any errors or discrepancies.

11. The method as claimed in claim 1, further comprising receiving feedback from the user based on the execution of the application.

12. The method as claimed in claim 11, further comprising employing real-time optimization algorithms to continuously refine the application based on performance metrics, user feedback, and changing environmental conditions.

13. A task execution system, comprising:
a memory comprising computer readable instructions;
a processor operatively coupled to the memory, the processor configured to execute one or more executable components, the one or more executable components comprising:
a user interface configured to receive a user request;
a discovery module configured to discover one or more existing solutions based on the user request, wherein the one or more existing solutions comprises, process-flows, sub-process-flows, integration flows, APIs, automation bots, applications, and system components;
a determination module configured to determine an existing solution of the one or more existing solutions that has a capability to perform a task;
an integration module configured to dynamically combine two or more existing solutions to create an application that has the capability to perform the task, based on a determination that none of the one or more existing solutions has the capability to perform the task; and
an execution module configured to execute the application to perform the task based on the user request.

14. The task execution system as claimed in claim 13, wherein the user request is analyzed using natural language processing (NLP) to determine application requirements.

15. The task execution system as claimed in claim 13, wherein the discovery of the one or more existing solutions comprises analyzing metadata associated with the process-flows, the sub-process-flows, the integration flows, the APIs, the automation bots, the applications, and the system components based on query parameters associated with the user request.

16. The task execution system as claimed in claim 13, wherein the combination of the two or more existing solutions for the creation of the application comprises:
defining an input, a process, an output, and an appropriate status for the application as per the user request; and
create a sequence for the two or more existing solutions within the application, wherein the creation of the sequence is based on dependencies and interdependencies among the two or more existing solutions.

17. The task execution system as claimed in claim 16, wherein the combination of the two or more existing solutions comprises identifying the two or more existing solutions based on predefined rules and logic tailored to requirements of the task.

18. The task execution system as claimed in claim 16, wherein the creation of the sequence for the two or more existing solutions comprises configuration of integration points and data flow paths between the process-flows, the sub-process-flows, the integration flows, the APIs, the automation bots, the applications, and the system components for facilitation of smooth collaboration and interaction.

19. The task execution system as claimed in claim 16, wherein a uniform protocol is employed for compatibility among the two or more existing solutions.

20. The task execution system as claimed in claim 16, wherein the integration module is configured to implement a common data model for collaboration and data exchange among the two or existing solutions.

21. The task execution system as claimed in claim 13, wherein the execution comprises interaction with a user to receive additional inputs to perform the task, wherein the user request corresponds to the user.

22. The task execution system as claimed in claim 13, wherein the execution module is further configured to monitor the execution of the application to detect and address any errors or discrepancies.

23. The task execution system as claimed in claim 1, further comprising receiving feedback from the user based on the execution of the application.

24. The task execution system as claimed in claim 23, further comprising employing real-time optimization algorithms to continuously refine the application based on performance metrics, user feedback, and changing environmental conditions.
